(19) United States
(12) Patent Application Publication
(10) Pub. No.: US 2016/0139735 A1
(43) Pub. Date: May 19, 2016

(54) OPTICAL TOUCH SCREEN

(71) Applicant: Quanta Computer Inc., Taoyuan City (TW)

(72) Inventor: Chien-Hung LIN, Taoyuan City (TW)

(73) Assignee: Quanta Computer Inc., Taoyuan City (TW)

(21) Appl. No.: 14/637,001

(22) Filed: Mar. 3, 2015

(30) Foreign Application Priority Data
Nov. 14, 2014 (TW) 103139586

(51) Int. Cl. G06F 3/042; H04N 5/225

(52) U.S. Cl. CPC G06F 3/0421; H04N 5/2257

(57) ABSTRACT

An optical touch screen includes a display panel, a first camera module, a second camera module, and a controller. The first camera module includes a first emitting unit and a first receiving unit. The first emitting unit is used for emitting a first light beam toward the surface of the display panel. The first receiving unit is used for capturing an image on the display panel. The second camera module includes a second emitting unit and a second receiving unit. The second emitting unit is used for emitting a second light beam toward the surface of the display panel. The second receiving unit is used for capturing another image on the display panel. The controller calculates a relative horizontal position of the object with the display panel, and determines whether a distance between the object and the display panel is located in a touch area or a hover area.

### RELATED APPLICATIONS

This application claims priority to Taiwan Application Serial Number 103139586, filed Nov. 14, 2014, which is herein incorporated by reference.

### BACKGROUND

1. Field of Invention

The present invention relates to a touch screen. More particularly, the present invention relates to an optical touch screen.

2. Description of Related Art

Touch technology refers to a control of an electronic device combining display panels and input modules by simply pressing or touching the display panel. An optical touch screen may have a cost advantage in the application of large-size touch screen. However, the optical touch screen has an increased weight because it is required to dispose a reflecting unit corresponding to a position of a light source that is used for detection of press or touch.

### SUMMARY

An aspect of the present invention provides an optical touch screen includes emitting units emitting images in different time intervals. Therefore, with receiving the images in different time intervals, a controller of the optical touch screen can exactly determine whether an operation of a user is a hover operation or a touch operation.

An aspect of the present invention provides an optical touch screen including a display panel, a first camera module, a second camera module, and a controller. The first camera module is disposed at a corner of the display panel and on a surface of the display panel, in which the first camera module includes a first emitting unit and a first receiving unit. The first emitting unit is used for emitting a first light beam toward the surface of the display panel. The first receiving unit is used for capturing an image on the display panel. The second camera module is disposed at another corner of the display panel and on the surface of the display panel, in which the second camera module includes a second emitting unit and a second receiving unit. The second emitting unit is s used for emitting a second light beam toward the surface of the display panel. The second receiving unit is used for capturing another image on the display panel. The controller is connected to the first receiving unit and the second receiving unit. When an object is located on the display panel, the controller calculates a relative horizontal position of the object with the display panel via the images transmitted by the first receiving unit and the second receiving unit, and the controller determines whether a distance between the object and the display panel is located in a touch area or a hover area via the image transmitted by the first receiving unit.

### BRIEF DESCRIPTION OF THE DRAWINGS

The invention can be more fully understood by reading the following detailed description of the embodiment, with reference made to the accompanying drawings as follows:

FIG. 1 is a front view of an optical touch screen according to a first embodiment of this invention;

FIG. 2A is a side view of an optical touch screen of this invention when an object does not enter a touch-operation region;

FIG. 2B is an image received by a first receiving unit in FIG. 2A;

FIG. 3A is a side view of an optical touch screen of this invention when an object enters a touch-operation region;

FIG. 3B is an image received by a first receiving unit in FIG. 3A;

FIG. 4A is a front view of defining a touch angle of an object with an optical touch screen according to an embodiment of this invention;

FIG. 4B is a front view of defining a touch position of an object with an optical touch screen according to an embodiment of this invention;

FIG. 5A is a front view of defining a touch area of an optical touch screen according to an embodiment of this invention;

FIG. 5B is an image received by a first receiving unit in FIG. 5A;

FIG. 6A is a time sequence diagram of emitting a first light beam and a second light beam in an optical touch screen according to a second embodiment of this invention;

FIG. 6B is a time sequence diagram of emitting a first light beam and a second light beam in an optical touch screen according to a third embodiment of this invention;

FIG. 7 is a front view of an optical touch screen according to a fourth embodiment of this invention;

FIG. 8A is a time sequence diagram of emitting light beams in an optical touch screen according to a fifth embodiment of this invention; and

FIG. 8B is a time sequence diagram of emitting light beams in an optical touch screen according to a sixth embodiment of this invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

In an optical touch screen of the present invention, since an object operating with touch, for example, a finger or a pen, is regarded as a reflective interface, disposing a reflecting unit on the optical touch screen is unnecessary such that the cost and weight of the optical touch screen are decreased. In addition, the optical touch screen emits light beams in different time intervals, and hence the optical touch screen can exactly determine whether an operation of a user is a hover operation or a touch operation via receiving the light beams in different time intervals.

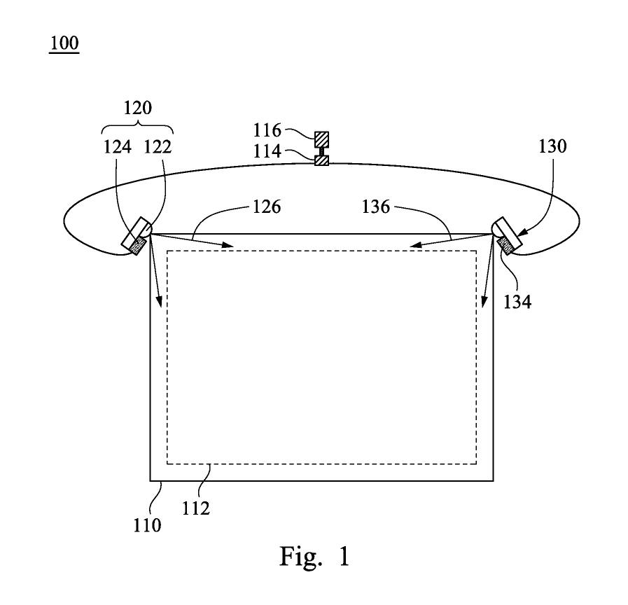

FIG. 1 is a front view of an optical touch screen according to a first embodiment of this invention. An optical touch screen 100 includes a display panel 110, a first camera module 120, a second camera module 130, and a controller 114. The first camera module 120 and the second camera module 130 are respectively disposed at two opposite corners of the display panel 110.

The first camera module 120 includes a first emitting unit 122 and a first receiving unit 124. The first emitting unit 122 is used for emitting a first light beam 126. For example, a first light emitter is disposed in the first emitting unit 122, such that the first emitting unit 122 can emit the first light beam 126 toward the surface of the display panel 110. The first receiving unit 124 is used for capturing an image (a first image) on the display panel 110. For example, a first light receiver is disposed in the first receiving unit 124. Therefore, when an object is close to the surface of the display panel 110, the first receiving unit 124 can receive the first light beam 126 reflected from the object (or the first receiving unit 124 can record an image of the object illuminated by the first light beam 126). In the present embodiment, the first camera module 120 and the second camera module 130 are the same modules substantially, and hence the relate description about the second camera module 130 is not described again. Thus, the first receiving unit 124 is used for capturing the first image, and the second receiving unit 134 is used for capturing a second image on the display panel 110. In some embodiments, the first emitting unit 122 and the first receiving unit 124 belong to an infrared-ray module that is invisible to the naked eyes.

The optical touch screen determines a touch operation in accordance with the reflective first light beam 126 and second light beam 136, and hence a space including the first light beam 126 and second light beam 136 expanding on the surface of the display panel 110 is defined as a touch-operation region 112. In addition, since the first light beam 126 and the second light beam 136 take the object touching on the display panel 110 as a reflective interface, disposing a reflecting unit on the edge of the display panel 110 is unnecessary such that the cost and weight of the optical touch screen 100 are reduced. In some embodiments, the space including the first light beam 126 and second light beam 136 expanding on the surface of the display panel 110 almost covers the display panel 110 or at least covers the touch-operation region 112.

The following descriptions are provided with respect to a method for detecting the touch operation on the optical touch screen 100. For making the description succinct, the following descriptions take the first camera module 120 as an example. In addition, for making the description succinct, the first emitting unit 122 and the first receiving unit 124 of the first camera module 120 are arranged in a horizontal direction, and the arranging direction is not limited thereto.

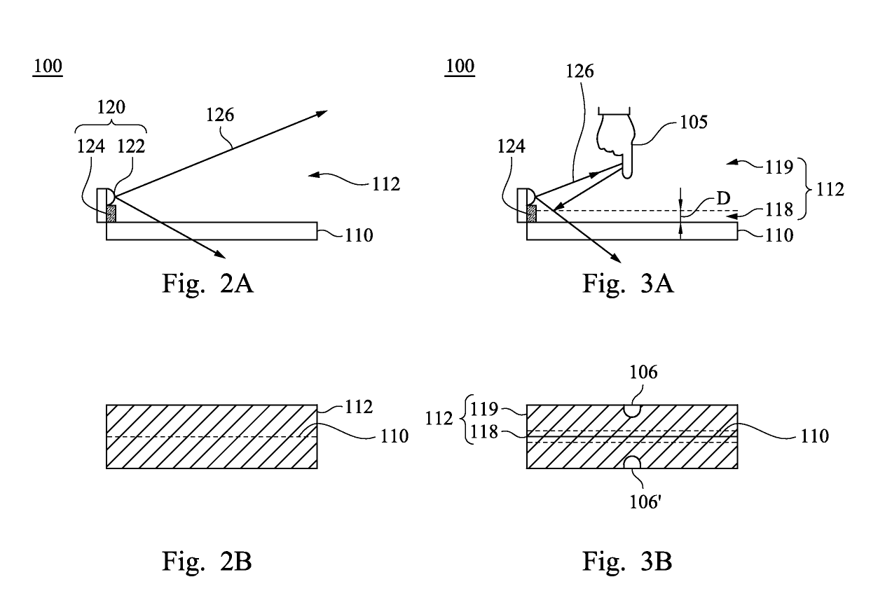

FIG. 2A is a side view of an optical touch screen of this invention when an object does not enter a touch-operation region, and FIG. 2B is an image received by a first receiving unit in FIG. 2A. The first light beam 126 emitted by the first emitting unit 122 is expanded toward two directions by a lens of the first emitting unit 122. One direction of the first light beam 126 is a horizontal direction, and the horizontal direction is parallel to the surface of the display panel 110. Another direction of the first light beam 126 is a vertical direction, and the vertical direction is orthogonal with the surface of the display panel 110. In some embodiments, a superposition region of the spaces expanded by the first light beam 126 and the second light beam 136 is the touch-operation region 112 of the optical touch module 100.

In FIG. 2A, when there is no object in the touch-operation region 112, i.e. no object that could be regarded as a reflective interface corresponding to the first light beam 126, the first light beam 126 can not enter the first receiving unit 124 via reflection.

In FIG. 2B, the first receiving unit 124 can receive images of the touch-operation region 112 and the display panel 110, in which the surface of the display panel 110 is illustrated as a dotted line in FIG. 2B. Since the object regarded as a reflective interface corresponding to the first light beam 126 doesn't exist, an image detected by the first receiving unit 124 is full black.

FIG. 3A is a side view of an optical touch screen of this invention when an object enters a touch-operation region, and FIG. 3B is an image received by a first receiving unit in FIG. 3A. In the present embodiment, a finger 105 is taken as a touch object as an example

In FIG. 3A, when the finger 105 enters the touch-operation region 112, a portion of the first light beam 126 is reflected from the finger 105 toward the first receiving unit 124. Meanwhile, in an image received by the first receiving unit 124, the finger 105 would be shown at the corresponding region. Therefore, in FIG. 3B, since the finger 105 is illuminated by the first light beam 126, a finger image 106 is shown at the region corresponding to the finger 105 in the image received by the first receiving unit 124. Furthermore, in the image received by the first receiving unit 124, the other portions that the first receiving unit 124 doesn't receive the reflective image are still full black. In addition, since the finger 105 is quite close to the display panel 110, the surface of the display panel 110 also reflects and shows a mirror image of the finger 105. Therefore, such mirror image of the finger 105 shown in the surface of the display panel 110 is also captured by the first receiving unit 124, and hence a mirror image of the finger 106′ is shown in the image received by the first receiving unit 124.

According to an embodiment of the present invention, a touch area 118 and a hover area 119 can be defined in the touch-operation region 112. In FIG. 3A, the touch area 118 is disposed on the surface of the display panel 110 and in a setting value (a distance between a dotted line and the surface of the display panel 110 in FIG. 3A). That is, when the finger 105 enters between the dotted line and the surface of the display panel 110 or directly touches the surface of the display panel 110, the finger 105 is regarded as in the touch area 118, and a corresponding control signal is triggered. The hover area 119 is defined as on the touch area 118 and out of the above setting value. In FIG. 3B, the touch area 118 defined as the above in the image is an area on the surface of the display panel 110 (the surface of the display panel 110 is illustrated as a solid line in FIG. 3B) and corresponding to the above setting value (a dotted line), in which such area or the touch area 118 is between the solid line and the dotted line. The hover area 119 defined as the above in the image is an area out of the dotted line, and hence the hover area 119 is on the dotted line. In addition, an area under the surface of the display panel 110 is a mirror area of the display panel 110.

As shown in FIG. 1 and FIG. 3A, the controller 114 is connected to the first receiving unit 124 and the second receiving unit 134. When the finger 105 is located on the display panel 110, the controller 114 calculates a relative horizontal position of the finger 105 with the display panel 110 (the touch position of the finger 105 on the display panel 110) via the images transmitted by the first receiving unit 124 and the second receiving unit 134 (the first image and the second image transmitted by the first receiving unit 124 and the second receiving unit 134 respectively). Similarly, the controller 114 determines whether a distance between the finger 105 and the display panel 110 is located in the touch area 118 or the hover area 119 via the image (first image) transmitted by the first receiving unit 124 (or/and the second receiving unit 134). In some embodiments, a range of the touch area 118 is under or equal to twice a detectable minimal pixel unit in the first receiving unit 124, and thus a distance unit D is under or equal to the detectable minimal pixel unit in the first receiving unit 124. That is, the above sitting value in FIG. 3A can be defined as the distance unit D.

When the finger 105 enters the touch-operation region 112 from other place, the controller 114 calculates the relative horizontal position of the finger 105 with the display panel 110 (or a horizontal coordinate) and determines that the finger 105 is in the hover area 119 according to the images of the finger 105 received by the first receiving unit 124 and the second receiving unit 134. Furthermore, when the finger 105 is moving in the hover area 119, the controller 114 simultaneously calculates the horizontal position of the moving finger 105. Moreover, when the finger 105 moves into the touch area 118, the controller 114 sends an electrical signal for representing a touch operation. The following descriptions are the further definitions of the touch area 118 and the hover area 119.

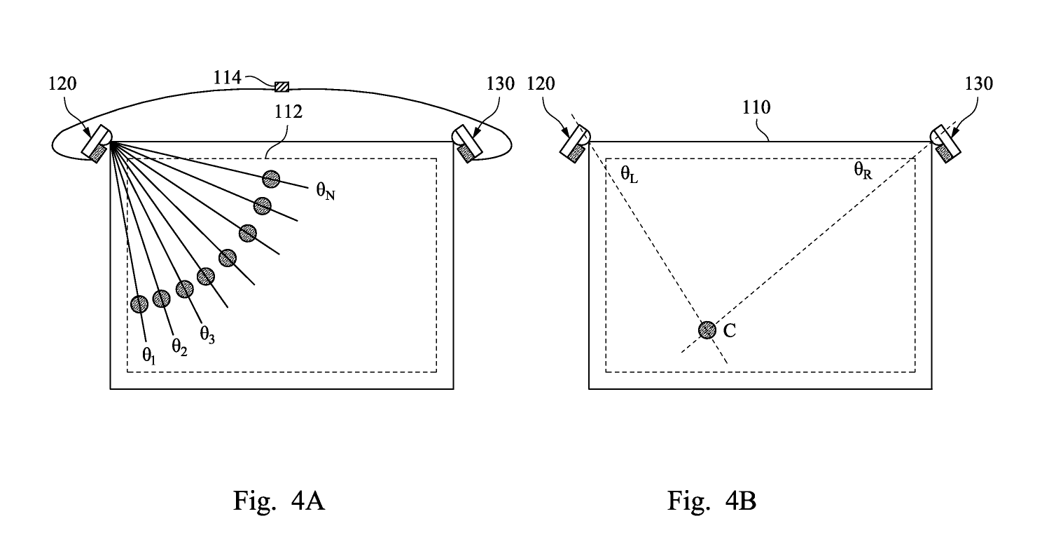

FIG. 4A is a front view of defining a touch angle of an object with an optical touch screen according to an embodiment of this invention. The first camera module 120 and the second camera module 130 emit light beams in touch-operation region 112 with different angles. For example, the first camera module 120 can simultaneously emit the light beams in directions θ₁, θ₂, θ₃, . . . , and θ_{N}.

Then, the angles of the light beams reflected from different locations corresponding to the first camera module 120 are defined. Since an object with different locations is shown in the image received by the first camera module 120 with different corresponding region, the controller 114 can figure out an angle between the object and the first camera module 120 according to the location of the object image captured by the first camera module 120 when the object touches.

FIG. 4B is a front view of defining a touch position of an object with an optical touch screen according to an embodiment of this invention. When the finger touches a point C on the display panel 110, by the aforementioned methods, angles θL and θR could be obtained. The angles θL and θR are respectively defined by the lines interconnecting the first camera module 120 and point C, and the second camera module 130 and point C. At this time, by trigonometry calculation or simultaneous point-slope equations combined with the given coordinates of the first camera module 120 and the second camera module 130, the coordinate of the point C on the display panel 110 can be obtained.

With the above method, the optical touch screen 100 can calculate the touch position of the object, and determining whether the object is in the hover area 119 or the touch area 118 is further described in the following embodiments.

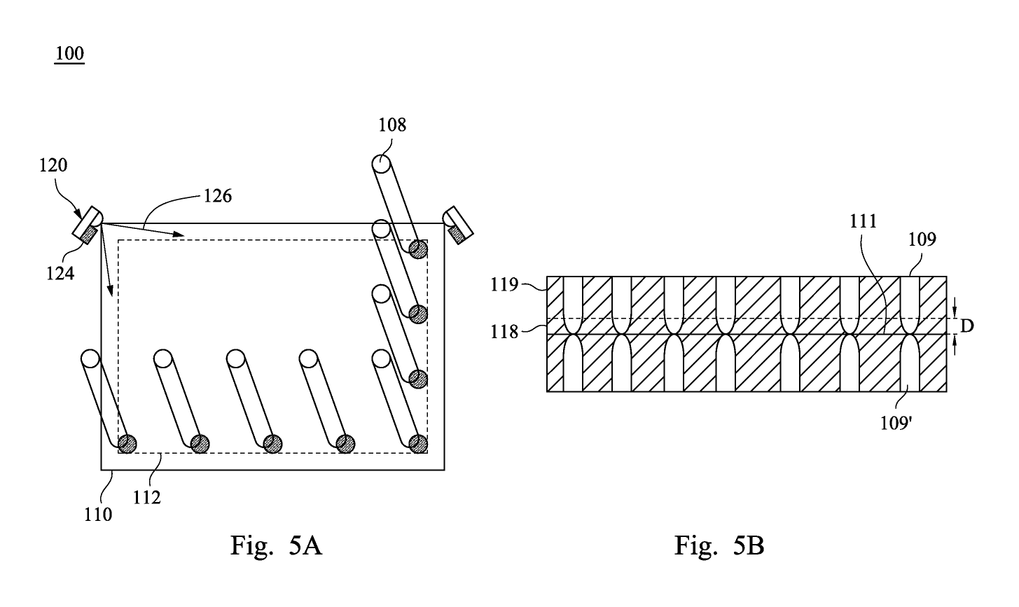

FIG. 5A is a front view of defining a touch area of an optical touch screen according to an embodiment of this invention, and FIG. 5B is an image received by a first receiving unit in FIG. 5A. In the present embodiment, how to define the touch area 118 of the touch-operation region 112 in the optical touch screen 100 by a test object 108 is stated, in which the test object 108 has a bar-like shape. Furthermore, how to determine the object is in the touch area 118 is also described in the present embodiment

In the present embodiment, the first camera module 120 is taken as an example for showing how to define the touch area 118. The touch area 118 is defined by the following steps. A first step is touching the surface of the display panel 110 by the test object 108. A second step is capturing an image on the display panel 110 by the first receiving unit 124. A third step is recording a point that the first light beam 126 reflected from the test object 108 on the display panel 110 coincides with the first light beam 126 reflected from an mirror image of the test object 108 in the display panel 110.

In some embodiments, the first step to the third step are repeated at the different positions of the surface of the display panel 110 for obtaining coincident points, as show in FIG. 5B, in which images 109 of the test object 108 and mirror images 109′ of the test object 108 are illustrated in FIG. 5B. Then, a plane including the coincident points is defined as a reference surface 111. Finally, the touch area 118 is set, in which a range of the touch area 118 is extended from the reference surface 111 toward a direction opposite the surface of the display pane 110 with one distance unit D. In some embodiments, the distance unit D is under or equal to twice the detectable minimal pixel unit in the first receiving unit 124.

Referring back to FIG. 1. In the image received by the first receiving unit 124, when the object image is in the touch area (see FIG. 3A), the controller 114 not only calculates a relative horizontal position of the object but also determines that the object touches the surface of the display panel 110, and the controller 114 sends an electrical signal representing a touch-operation. On the other hand, if the object image is in the touch-operation region 112 but not in the touch area (see FIG. 3A), the controller 114 determines that the object is in the hover area (see FIG. 3B). In such case, the controller 114 only calculates the relative horizontal position of the object without sending the electrical signal representing the touch-operation, and the object operation is regard as a moving mouse or a moving cursor.

In some embodiments, the optical touch screen 100 further includes an output 116, in which the output 116 is a socket that can connect with a universal serial bus (USB) plug or other plug of an electronic device. For example, the electronic device is a computer or a smart device.

The following description is a practical application of the optical touch screen 100 with connecting with an electronic device. When the object enters the touch-operation region 112 and starts touching, the controller 114 calculates a relative horizontal position of the object with the display panel 110. Then, the controller 114 further determines whether the object is in the touch area (see FIG. 3A). If the object isn't in the touch area but in the hover area (see FIG. 3A), the object is regard as a moving cursor. On the other hand, if the object is in the touch area, the object is regard as a clicking cursor. Furthermore, since the finger is traced by the controller 114 in the hover area, in addition to basic operations, a touch posture can be defined by the optical touch screen 100. For example, a drag operation or enlarging a display window.

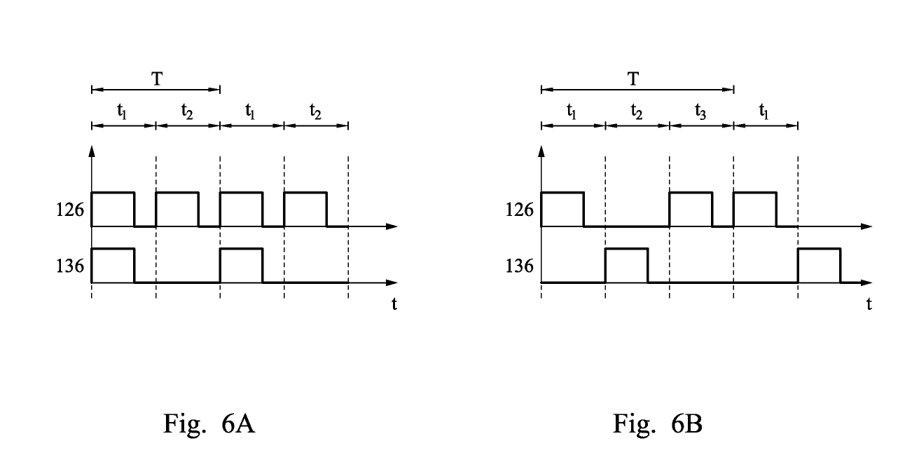

FIG. 6A is a time sequence diagram of emitting a first light beam and a second light beam in an optical touch screen according to a second embodiment of this invention. The first light beam 126 and the second light beam 136 are emitted in the same period with different time intervals. In the present embodiment, the period T has two time intervals, a first time interval t₁ and a second time interval t₂.

In the first time interval t₁, the first light beam 126 and the second light beam 136 are respectively emitted by the first emitting unit and the second emitting unit. When an object starts touching, the controller calculates a relative horizontal position of the object by the above method. In the second time interval t₂, the first light beam 126 is emitted by the first emitting unit, and the controller determines whether the object image is in the touch area. According to a location of the object image, the controller determines whether to send the electronic signal representing the touch-operation. Moreover, the controller can complete calculating the relative horizontal position of the object and determining whether the object is in the touch area or hover area after one period.

FIG. 6B is a time sequence diagram of emitting a first light beam and a second light beam in an optical touch screen according to a third embodiment of this invention. The difference between the present embodiment and the second embodiment is that the period T of the present embodiment has three time intervals, a first time interval t₁, a second time interval t₂, and a third time interval t₃.

In the first time interval t₁ and the second time interval t₂, the first light beam 126 and the second light beam 136 are respectively emitted by the first emitting unit and the second emitting unit. When an object starts touching, the controller calculates a relative horizontal position of the object. In the third time interval t₃, the first light beam 126 is emitted by the first emitting unit. Similarly, the controller determines whether to send the electronic signal representing the touch-operation.

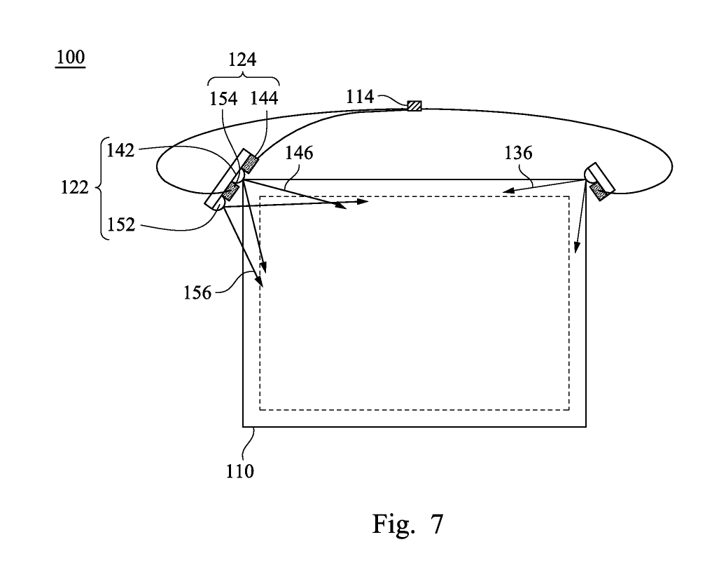

FIG. 7 is a front view of an optical touch screen according to a fourth embodiment of this invention. The difference between the present embodiment and the first embodiment is that the first light beam is formed by a third light beam and a fourth light beam.

In the present embodiment, the first emitting unit 122 provides the third light beam 146 and the fourth light beam 156. For example, a third light emitter 142 and a fourth light emitter 152 can be disposed in the first emitting unit 122, such that the first emitting unit 122 emits the third light beam 146 and the fourth light beam 156 toward the surface of the display panel 110. The third light beam 146 and the fourth light beam 156 are emitted in the same period with different time intervals. Similarly, the first receiving unit 124 is used for receiving the image (the first image). For example, a third light receiver 144 and a fourth light receiver 154 are disposed in the first receiving unit 124. Therefore, when an object is close to the surface of the display panel 110, the third light beam 146 and the fourth light beam 156 reflected from the object are respectively received by the third light receiver 144 and the fourth light receiver 154, and the images captured by the third light receiver 144 and the fourth light receiver 154 (a third image and a fourth image respectively) are transmitted to the controller 114.

In the present embodiment, when the object is located on the surface of the display panel 110, the controller 114 calculates a relative horizontal position of the object with the display panel 110 via the reflected second light beam 136 and the reflected third light beam 146. Then, the controller 114 determines whether a distance between the object and the display panel 110 is in the touch area or the hover area via the reflected fourth light beam 156. In the following embodiments, descriptions are provided with respect to a time sequence of emitting light beams.

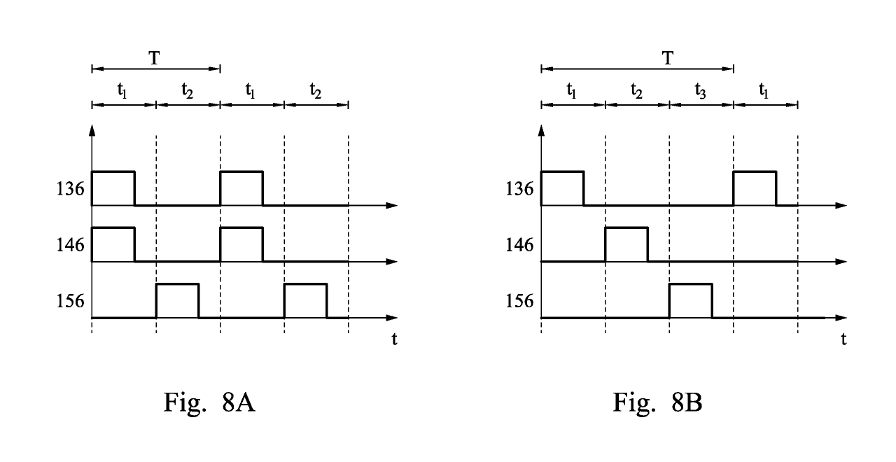

FIG. 8A is a time sequence diagram of emitting light beams in an optical touch screen according to a fifth embodiment of this invention. The third light beam 146 and the fourth light beam 156 are emitted in the same period with different time intervals. In the present embodiment, the period T has two time intervals, a first time interval t₁ and a second time interval t₂.

In the first time interval t₁, the second light beam 136 and the third light beam 146 are respectively emitted by the second emitting unit and the third emitting unit. When an object starts touching, the controller 114 (see FIG. 7) calculates a relative horizontal position of the object with the display panel 110. In the second time interval t₂, the fourth light beam 156 is emitted by the fourth emitting unit. The controller determines whether to send an electronic signal representing the touch-operation. Moreover, the controller can complete calculating the relative horizontal position of the object and determining whether the object is in the touch area or the hover area after one period.

FIG. 8B is a time sequence diagram of emitting light beams in an optical touch screen according to a sixth embodiment of this invention. The difference between the present embodiment and the fifth embodiment is that the period T of the present embodiment has three time intervals, a first time interval t₁, a second time interval t₂, and a third time interval t₃.

In the first time interval t₁ and the second time interval t₂, the second light beam 136 and the third light beam 146 are respectively emitted by the second emitting unit and the third emitting unit. When an object starts touching, the controller calculates a relative horizontal position of the object. In the third time interval t₃, the fourth light beam 156 is emitted by the fourth emitting unit. Similarly, the controller determines whether to send an electronic signal representing the touch-operation.

The optical touch screen of the present invention emits the light beams and takes the touch object as the reflective interface, and hence disposing a reflecting unit on the display panel is unnecessary such that the cost and weight of the optical touch screen are reduced. In addition, the optical touch screen emits light beams in different time intervals, such that the controller can exactly calculate the position of the object and determine whether the object touches on the display panel. Furthermore, the touch area of the touch-operation region of the optical touch screen can be set with different conditions, such that the touch accuracy is improved.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An optical touch screen, comprising:
a display panel;
a first camera module disposed at a corner of the display panel and on a surface of the display panel, and comprising:
a first emitting unit emitting a first light beam toward the surface of the display panel; and
a first receiving unit capturing a first image on the display panel;
a second camera module disposed at another corner of the display panel and on the surface of the display panel, and comprising:
a second emitting unit emitting a second light beam toward the surface of the display panel; and
a second receiving unit capturing a second image on the display panel; and
a controller connected to the first receiving unit and the second receiving unit, wherein when an object is located on the display panel, the controller calculates a relative horizontal position of the object with the display panel via the first image and the second image transmitted by the first receiving unit and the second receiving unit respectively, and the controller determines whether a distance between the object and the display panel is located in a touch area or a hover area via the first image transmitted by the first receiving unit.

2. The optical touch screen of claim 1, wherein the touch area is in a range under or equal to twice a detectable minimal pixel unit in the first receiving unit.

3. The optical touch screen of claim 1, wherein the first light beam comprises a third light beam and a fourth light beam that are emitted in the same period with different time intervals, wherein when the object is located on the surface of the display panel, the controller calculates the relative horizontal position of the object with the display panel via the first image and the second image transmitted by the first receiving unit and the second receiving unit respectively, wherein the first image and the second image transmitted by the first receiving unit and the second receiving unit are respectively corresponding to the third light beam and the fourth light beam, and the controller determines whether the distance between the object and the display panel is in the touch area or the hover area via the first image transmitted by the first receiving unit and corresponding to the fourth light beam.

4. The optical touch screen of claim 1, wherein the first emitting unit comprises:
a third light emitter emitting a third light beam toward the surface of the display panel; and
a fourth light emitter emitting a fourth light beam toward the surface of the display panel, wherein the third light beam and the fourth light beam are emitted in the same period with different time intervals; and
wherein the first receiving unit comprises:
a third light receiver capturing a third image on the display panel; and
a fourth light receiver capturing a fourth image on the display panel.

5. A method for detecting a touch position on an optical touch screen, comprises:
emitting a first light beam and a second light beam toward a surface of a display panel, wherein the first light beam and the second light beam are respectively emitted from two adjacent corners of the display panel;
receiving images of the surface of the display panel via a first receiving unit and a second receiving unit, wherein when an object is located on the surface of the display panel, the first receiving unit and the second receiving unit respectively receive the first light beam and the second light beam which are reflected from the object;
transmitting the images received by the first receiving unit and the second receiving unit to a controller;
calculating a relative horizontal position of the object with the display panel via the images received by the first receiving unit and the second receiving unit; and
determining whether a distance between the object and the display panel is located in a touch area or a hover area via the image received by the first receiving unit.

6. The method of claim 5, wherein the step of defining the touch area comprises:
(a) touching the surface of the display panel by a test object;
(b) capturing the image on the display panel by the first receiving unit or the second receiving unit;
(c) recording a point that a light beam reflected from the test object on the display panel coincides with a light beam reflected from an mirror image of the test object in the display panel;
repeating step(a) to step(c) at the different positions of the surface of the display panel for obtaining a plurality of coincident points, wherein a plane comprising the coincident points is defined as a reference surface; and
setting the touch area, wherein a range of the touch area is extended from the reference surface toward a direction opposite the surface of the display pane with a distance unit.

7. The method of claim 6, wherein the distance unit is under or equal to twice a detectable minimal pixel unit in the first receiving unit or the second receiving unit.

8. The method of claim 5, wherein the first light beam and the second light beam are emitted alternately.

9. The method of claim 5, wherein the times of emitting the first light beam and the second light beam are partially overlapped.

10. The method of claim 5, wherein the first light beam comprises a third light beam and a fourth light beam that are emitted in the same period with different time intervals, wherein the controller determines the relative horizontal position of the object with the display panel via the reflected second light beam and the reflected third beam, and the controller determines whether the distance between the object and the display panel is located in the touch area or the hover area via the reflected fourth light beam.
